(19) United States
(12) Patent Application Publication
(10) Pub. No.: US 2011/0045178 A1
(43) Pub. Date: Feb. 24, 2011

(54) METHOD FOR THE ADJUSTMENT OF DEFINED MORPHOLOGIES OF SEGREGATED PHASES IN THIN LAYERS

(75) Inventors: Horst Hintze-Brüning, Munster (DE); Hans-Peter Steiner, Sendenhorst (DE); Fabrice Leroux, Le Cendre (FR); Anne-Lise Troutier, Clermont-Ferrand (FR)

Correspondence Address: Mary E. Golota;Cantor Colburn LLP, 201 W. Big Beaver Road, Suite 1101, Troy, MI, 48084, US

(73) Assignees: BASF COATINGS GMBH, Muenster (DE); UNIVERSITÉ BLAISE PASCAL, Clermont-Ferrand (FR)

(21) Appl. No.: 12/742,795

(22) PCT Filed: Nov. 6, 2008
(86) PCT No.: PCT/EP2008/009325

§ 371 Date: Oct. 4, 2010

(30) Foreign Application Priority Data
Nov. 14, 2007 (DE) 10 2007 054 242.0

(51) Int. Cl. B05D 5/06

(52) U.S. Cl. 427/197

(57) ABSTRACT

A method of establishing defined morphologies of separated phases in thin coats, in which anisotropic particles (T) whose average particle diameter (D) is <1 μm and whose D/d ratio of the average particle diameter (D) to the average particle thickness (d) is >50 are introduced into the coating material used to produce said coats and comprises at least one polymer (P1), at least one polymer (P2) which is incompatible with the polymer (P1) in the solid phase and/or a crosslinking agent (V) which is incompatible with the polymer (P1) in the solid phase, where the polymers (P1) and/or (P2) have at least one functional group (a) which reacts during curing of the coating material to form covalent bonds. The disclosed coating material is applied to an uncoated substrate and/or to a precoated substrate and then cured and can be used in producing antistonechip OEM coat systems.

The provision of stonechip-resistant coatings on metallic substrates is of especial importance in the field of automotive manufacture. A surfacer or antistonechip primer is subject to a series of requirements. Hence the surfacer coat after curing is to bring about high stonechip resistance, more particularly in respect of multiple impact, and at the same time effective adhesion to the anticorrosion coat, more particularly to the cathodic electrodeposition coat (electrocoat for short) and to the basecoat, good filling properties (hiding the structure of the substrate) at coat thicknesses of about 20 to 35 μm, and good appearance in the context of the concluding clearcoat. Moreover, suitable coating materials, not least on environmental grounds, are to be preferably low in, or very substantially free from, organic solvents.

Coating materials for surfacers are known and are described in, for example, EP-A-0 788 523 and EP-A-1 192 200. Described therein are water-dilutable polyurethanes as binders for surfacers which are intended to ensure stonechip resistance, particularly at comparatively low coat thicknesses. On exposure in stonechip tests, however, in spite of good stonechip resistance, in other words a comparatively small number of instances of damage, the prior-art surfacers in OEM coat systems (anticorrosion coat (more particularly electrocoat)/surfacer/basecoat/clearcoat), nevertheless frequently exhibit damage patterns on the paint film where the unprotected metal substrate is exposed as a result of uncontrolled crack propagation in the OEM coat system and subsequent delamination at the interface between metal and electrocoat.

WO-A-01/04050 discloses inorganic anionic or cationic layered fillers for aqueous coating materials having good barrier properties, modified with organic compounds to widen the distance between the layers in the filler, said organic compounds having at least two ionic groups separated by at least four atoms. Cationic fillers employed may be double-layered hydroxides, such as, more particularly, hydrotalcite types. The coating materials described in WO-A-01/04050 are used for coatings having very good barrier properties with respect to gases and liquids, the fillers being said not to affect the curing operation. The use of the coating materials to improve the damage patterns after impact exposure in OEM coat systems, more particularly for reducing the surface area of exposed substrate, is unknown.

It is also known from scientific publications that the phase morphology of polymers can be influenced by addition of nanoparticles. For example, N. Hasegawa et al. (Polym. Bull. 51 (2003), 77-83) and R. Krishnamoorti et al. (J. Chem. Phys. 115 (2001), 7166, ibidem 7175) have reported the control of the three-dimensional arrangement of the microdomains of block copolymers by the presence of sheet silicate particles as templates. G. He et al. (J. Polym. Sci. Part B: Polym. Phys. 44 (2006), 2389) modeled the phase behavior of binary polymer mixtures in the presence of particles, including as a function of particle number, particle size and the affinity of the particle surface for the polymer components. The influence of sheet silicates with different aspect ratios on the spinodal separation behavior in the model system composed of polystyrene and polyvinyl methyl ether has been analyzed by K. Yurekli et al. (Macromolecules 36 (2003), 7256).

All systems described to date are binary systems with defined polymers with regard to their molecular weight distribution. Such model polymers can be prepared synthetically only with difficulty and, owing to their homogeneous primary structure (sequence of the monomer units), are unsuitable as a coating material for OEM coat systems.

WO-A-2005/052077 discloses coating materials, especially for producing surfacer coats, which comprise a film-forming component comprising binder resin with functional groups, and a crosslinker with at least two functional groups, which, after application and subsequent curing, form a bicontinuous phase morphology in the cured coat. This is achieved preferably by using, in the film-forming component, in addition to the polyurethane component used as the binder resin, a water-dispersible polymer component which is incompatible with said polyurethane component. The incompatibility of the polymer components is described by the interaction parameter χ (chi) according to the lattice model of Flory and Huggins, and by the difference in the Hildebrand solubility parameters δ of the polymer components which can be correlated with the interaction parameter.

The coating materials described in WO-A-2005/052077 have improved damage patterns after curing as a surfacer coat in OEM coat systems. However, there is a need for further improvement in the stonechip resistance of surfacer coats and especially for further improvement in the damage patterns. Moreover, the establishment of the bicontinuous morphology of the separated phases in the cured coat according to WO-A-2005/052077 is dependent not only on the thermodynamic parameter of the interaction parameters of the binders χ (chi). The model according to Flory and Huggins is limited to polymers without specific interactions, for example hydrogen bonds or ionic attraction or repulsion (Paul J. Flory, Principles of Polymer Chemistry, Cornell University Press (New York), 1953). In the case of polyurethanes with N—H groups capable of forming hydrogen bonds and with ion-forming groups, as used to formulate water-thinnable paint systems (see, for example, EP-A-0 788 523 and EP-A-1 192 200), both interaction types are to be expected. As is well known, hydrogen bonds in segmented polyurethanes lead to the formation of microdomains of the hard urethane-containing segments (The Polyurethanes Book, Wiley, 2002—ISBN 0470850418). G. Wilkes and A. Aneja (Polymer 44 (2003), 7221) were able to show, using segmented model polyurethanes, that hard microdomains can be formed even without the presence of hydrogen bonds.

It is also known that spinodal separation of incompatible polymers is a function of temperature. For example, a polymer mixture which undergoes spinodal separation and is incompatible at room temperature may be compatible at higher temperatures and form a homogeneous phase (the system exhibits a so-called UCST=upper critical solution temperature) or vice versa (the system exhibits an LCST=lower critical solution temperature). The surfacers described in WO-A-2005/052077 comprise polymer mixtures whose phase behavior can be described only insufficiently by means of the enthalpic interaction parameter according to Flory; moreover, they are formulated to pigmented paint systems which can be characterized as microcomposites, i.e. they comprise pigment particles on the micrometer scale in high pigment-to-binder (=polymer mixture) ratios. The resulting optical properties of the films of such systems rule out their broad applicability, for example in effect basecoats or clearcoats. In addition, it is known from theoretical studies by A. Balasz and V. Ginzburg et al. (J. Polym. Sci. Part B: Polym. Phys. 44 (2006), 2389 and J. Chem. Phys. 115 (2001), 3779) that the spinodal separation of binary polymer systems, by virtue of the presence of particles, depending on further physical parameters (for example osmosis-related hydrodynamic effects) can be either hindered (for example immobile non-neutral particles, i.e. particles having an affinity for one polymer component, constitute a thermodynamic barrier for the moving phase interface) or accelerated (mobile, non-neutral particles are transferred to the phase for which their particle surface has a higher affinity). The pigments of WO-A-2005/052077, which are present on the micrometer scale and can be considered as immobile particles, additionally act in mechanical terms exclusively as a reinforcing component in the microcomposite, i.e. they lead to an increase in the stiffness, measurable, for example, as an increased modulus of elasticity or as an increased tensile strength. This property, which is positive for many applications, is only of limited benefit for an improvement in the stonechip resistance, since, in the event of a projectile penetrating into the material, reducing its penetration depth by virtue of an increased resistance (=increased strength of the material) is not the only important factor, another being to increase the toughness of the material displaced during the penetration of the projectile, i.e. its capacity to dissipate the kinetic energy introduced, without premature crack formation and uncontrolled crack propagation leading to flaking of the paint material (delamination). For instance, D. Gersappe (Phys. Rev. Lett. 89 (2002), 058301) showed that particles can increase the toughness of a given polymer material when they can be mobile in the polymer matrix on a timescale comparable to the polymer motions. Studies by B. Finnigan et al. (Macromolecules 38 (2005), 7386) have additionally shown, in nanocomposites composed of segmented polyurethanes and sheet silicates, that larger immobile particles (tactoids of silicates with large aspect ratio) concentrate mechanical stress in a localized manner and thus cause cavities in the adjacent matrix, which lead to premature mechanical failure of the material. It is thus evident that the establishment of the phase morphology in thin coats can be realized only with difficulty and depends on a multitude of parameters, especially when the thin coats, taken alone or as a constituent of coat systems, particularly of OEM coat systems, are to have an improved damage pattern on impact exposure.

### PROBLEM AND SOLUTION

In the light of the prior art, a problem which is left to be addressed by the present invention is the provision of a process for controlling the morphology of separated phases in thin coats, which is to be suitable especially for OEM coat systems. The coating materials used in processes according to the invention should preferably be those based on ecologically advantageous aqueous coating materials, which, after curing, lead to stonechip-resistant coatings with a significantly improved damage pattern, especially with a significant reduction in the delamination of the OEM paint system at the interface between metal and anticorrosion coat and hence with a significant reduction in the exposed substrate surface area after impact exposure.

Surprisingly, a process has been found for controlling the morphology of separated phases in thin coats, in which anisotropic particles (T) whose mean particle diameter (D) is <1 μm and whose D/d ratio of the mean particle diameter (D) to the mean particle thickness (d) is >50 are introduced into the coating material that is used to produce said coats and that comprises at least one polymer (P1), at least one polymer (P2) which is incompatible with the polymer (P1) in the solid phase and/or a crosslinking agent (V) which is incompatible with the polymer (P1) in the solid phase, where the polymers (P1) and/or (P2) have at least one functional group (a) which reacts in the course of curing of the coating material to form covalent bonds, the coating material is applied to an uncoated substrate and/or to a precoated substrate and then cured.

Also found has been a process for producing antistonechip OEM coat systems consisting of an anticorrosion coat applied directly on the substrate, a surfacer coat, a basecoat and a final clearcoat, in which at least one layer is formed by the process according to the invention.

### DESCRIPTION OF THE INVENTION

As components essential to the invention, the coating material to be used for the method of the invention comprises at least one polymer (P1), at least one polymer (P2) incompatible with the polymer (P1) in the solid phase and/or a crosslinking agent (V) incompatible with the polymer (P1) in the solid phase, where the polymers (P1) and/or (P2) have at least one functional group (a) which reacts in the course of curing of the coating material to form covalent bonds, and anisotropic particles (T) whose mean particle diameter (D) (in the case of noncircular particles, the particle diameter corresponds to the longest area diagonal of the particle) is <1 μm and whose D/d ratio of the mean particle diameter (D) to the mean particle thickness (d) is >50.

The polymer (P1) is incompatible with the polymer (P2) and/or with the crosslinking agent (V) in the solid phase, i.e. (P1) forms phase interfaces in the thermodynamic equilibrium with (P2) and/or with (V) in a solid mixture.

According to Hildebrand's approach to describing the compatibility between two polymers, the description of the interaction parameter χ (chi) is possible through the difference of the cohesion energy densities or the solubility parameters δ of the polymer components, which can be derived from the quotient of the enthalpy of evaporation and the molar volume of the mixture components. Such solubility parameters δ take into account solely the enthalpic interactions between the polymeric mixture components, and the preferred critical value for the separation of a binary polymer mixture of components (P1) and (P2) or (P1) and (V) can be defined as the magnitude of the difference [δ(P1)−δ(P2) and/or δ(V)] of the Hildebrand solubility parameters δ(P1) of the polymer (P1) and δ(P2) of the polymer (P2) and/or δ(V) of the crosslinking agent (V) of at least 1, preferably at least 1.5, more preferably at least 2 (see also WO-A-2005/052077).

Suitable polymers (P1) and (P2) are in principle all polymers which are incompatible. The polymers are preferably selected from the group of polyurethanes, polyesters, polyamides, polyethers, polyepoxides and/or polyacrylates, particular preference being given to polyurethanes and/or polyesters. The polymers (P1) and/or (P2) have at least one functional group (a) which reacts in the course of curing of the coating material to form covalent bonds.

The crosslinking of the functional groups (a) may be induced by radiation and/or thermally.

Radiation-crosslinkable groups (a) are generally groups which, through exposure to actinic radiation, become reactive and are preferably able to enter, together with other activated groups of their kind, into reactions involving formation of covalent bonds, these reactions proceeding in accordance with a free-radical and/or ionic mechanism. Examples of suitable groups are single C—H bonds, single or double C—C, C—O, C—N, C—P or C—Si bonds, with preference being given to double C—C bonds. In one embodiment of the invention, the radiation-crosslinkable groups (a) preferably react with themselves.

In the preferred embodiment of the invention the crosslinking of the functional groups (a) is induced thermally, the groups (a) reacting with themselves that is, with other groups (a) and/or, with preference, with complementary functional groups (b). The selection of the functional groups (a) and also of the complementary functional groups (b) is guided on the one hand by the consideration that they should not enter into any unwanted reactions, more particularly no premature crosslinking, during the preparation of the polymers (P1) and/or (P2) and also during the preparation, storage, and application of the coating materials, and secondly by the temperature range within which the crosslinking is to take place.

By way of example of groups (a) which react with themselves, mention may be made of the following: methylol, methylol ether, N-alkoxymethyl-amino and, more particularly, alkoxysilyl groups.

By way of example of inventively preferred pairings of groups (a) and complementary functional groups (b), mention may be made of the following: hydroxyl groups (a) with acid, acid anhydride, carbamate, unetherified or etherified methylol groups and/or nonblocked or blocked isocyanate groups as functional group (b); amino groups (a) with acid, acid anhydride, epoxy and/or isocyanate groups as functional group (b); epoxy groups (a) with acid and/or amino groups as functional group (b); and mercapto groups (a) with acid, acid anhydride, carbamate and/or isocyanate groups as functional group (b). In one particularly preferred embodiment of the invention the complementary functional groups (b) are the constituent of a crosslinking agent (V), which is described later on.

More particularly, hydroxyl, amino and/or epoxy groups are preferred groups (a). Particular preference as groups (a) is given to hydroxyl groups, in which case the OH numbers of the polymers (P1) and/or (P2) according to DIN EN ISO 4629 are preferably between 10 and 200, more preferably between 15 and 150.

The functional groups (a) are introduced into the polymers (P1) and/or (P2) via the incorporation of suitable molecular building blocks, in a way which is known to the skilled worker.

In a preferred embodiment of the invention, the polymers (P1) and/or (P2), preferably (P1) and (P2) are water-dispersible polymers (WP1) and (WP2), and are especially selected from the group consisting of water-dispersible polyurethanes, polyesters, polyamides, polyethers, polyepoxides, and polyacrylates, with water-dispersible polyurethanes and/or polyesters being especially preferred.

Water-dispersible in the sense of the invention means that the polymers (WP1) and/or (WP2) in the aqueous phase form aggregates having an average particle diameter of preferably <500, more preferably <200, and most preferably <100 nm, or are in molecularly dispersed solution. The size of the aggregates composed of polymer (WP1) and/or (WP2) can be accomplished in a known way by introducing hydrophilic groups on the polymer (WP1) and/or (WP2). The water-dispersible polymers (WP1) and/or (WP2) preferably have mass-average molecular weights Mw (determinable by gel permeation chromatography using polystyrene as standard) of 1000 to 100 000 daltons, more preferably of 1500 to 50 000 daltons.

The preferred water-dispersible polyurethanes (WP1) and/or (WP2) can be prepared from building blocks of the kind described, for example, in DE-A-35 45 618 or DE-A-40 05 961. Incorporated in the polyurethane molecules are, preferably, groups capable of forming anions, these groups, following their neutralization, ensuring that the polyurethane resin can be stably dispersed in water. Suitable groups capable of forming anions are preferably carboxyl groups, sulfonic acid groups, and phosphonic acid groups, more preferably carboxyl groups. The acid number of the water-dispersible polyurethanes (WP1) and/or (WP2) according to DIN EN ISO 3682 is preferably between 10 and 80 mg KOH/g, more preferably between 20 and 60 mg KOH/g. The groups capable of forming anions are preferably neutralized using ammonia, amines and/or amino alcohols, such as diethylamine and triethylamine, dimethylaminoethanolamine, diisopropanolamine, morpholines and/or N-alkylmorpholines, for example. As functional group (a) it is preferred to use hydroxyl groups, in which case the OH numbers of the water-dispersible polyurethanes (WP1) and/or (WP2) according to DIN EN ISO 4629 are preferably between 10 and 200, and more preferably between 15 and 150.

Particularly preferred water-dispersible polyurethanes (WP1) and/or (WP2) are formed from hydroxy-functional polyester precursors which are preferably reacted with mixtures of bisisocyanato compounds, preferably hexamethylene diisocyanate, isophorone diisocyanate, TMXDI, 4,4′-methylenebis(cyclohexyl isocyanate), 4,4′-methylenebis-(phenylyl isocyanate), 1,3-bis(1-isocyanato-1-methylethyl)benzene, and compounds capable of forming anions, especially 2,2-bis(hydroxy-methyl)propionic acid, to give the polyurethane. Optionally, the polyurethanes can be constructed in branched form by virtue of the partial use of polyols, preferably triols, more preferably 1,1,1-tris(hydroxymethyl)propane, in amounts corresponding to 0 to 40, preferably 0 to 30 mol % of the equivalents of hydroxyl groups used. The hydroxy-functional polyester precursors are preferably constructed from diols and dicarboxylic acids, as described, for example, in DE-A-36 36 368 or DE-A-40 05 961. Particular preference is given to using mixtures of aromatic and/or aliphatic dicarboxylic acids and of aliphatic diols, in which case 10 to 90 mol %, preferably 20 to 80 mol %, based on the dicarboxylic acid and/or diol mixture, consists of dicarboxylic acids and/or diols which have at least one aliphatic side group consisting of at least 6 carbon atoms.

The water-dispersibility of the polyurethanes is achieved by neutralizing the groups capable of anion formation, preferably with amines, more preferably with diethanolamine, preference being given to a degree of neutralization between 80 and 100%, based on the totality of the neutralizable groups.

The preferred water-dispersible polyesters (WP1) and/or (WP2) can be prepared from building blocks of the kind described, for example, in DE-A-36 36 368 or DE-A-40 05 961. Incorporated in the polyester molecules are, preferably, groups capable of forming anions, these groups, following their neutralization, ensuring that the polyester resin can be stably dispersed in water. Suitable groups capable of forming anions are preferably carboxyl groups, sulfonic acid groups, and phosphonic acid groups, more preferably carboxyl groups. The acid number of the polyester resins according to DIN EN ISO 3682 is preferably between 10 and 100 mg KOH/g, more preferably between 20 and 80 mg KOH/g. The groups capable of forming anions are preferably likewise neutralized using ammonia, amines and/or amino alcohols, such as diethylamine and triethylamine, dimethylaminoethanolamine, diisopropanolamine, morpholines and/or N-alkylmorpholines, for example. As functional group (a) it is preferred to use hydroxyl groups, in which case the OH numbers of the water-dispersible polyester according to DIN EN ISO 4629 are preferably between 10 and 200, and more preferably between 20 and 150.

Particularly preferred water-dispersible polyesters (WP1) and/or (WP2) can be prepared from hydroxy-functional polyester precursors composed of mixtures of aromatic and aliphatic dicarboxylic acids with mixtures of aliphatic diols and polyols, preferably triols, preferably 1,1,1-tris(hydroxymethyl)propane. The polyols are preferably used in a stoichiometric excess, such that the polyester precursors preferably have acid numbers less than 1 and hydroxyl numbers between 100 and 500. The molecular weights are preferably between 300 and 1000. The water-dispersible polyesters are obtained by esterifying the polyester precursors with compounds capable of forming anions, especially 1,2,4-benzenetricarboxylic anhydride. The water dispersibility of the polyesters is preferably achieved by neutralizing the groups capable of forming anions, preferably with amines, more preferably with diethanolamine, preference being given to a degree of neutralization between 80 and 100%, based on the totality of the neutralizable groups.

In the coating material of the invention the polymers (P1) and (P2) are present preferably in fractions of 10% to 95% by weight, preferably of 20% to 80% by weight, based on the nonvolatile fractions of the coating material.

The crosslinking agent (V) used in the preferred embodiment of the invention has at least two crosslinkable functional groups (b) which, as complementary functional groups, react with the functional groups (a) of the polymers (P1) and (P2) or (WP1) and/or (WP2) and/or further constituents of the binder when the coating material is cured, with formation of covalent bonds. The functional groups (b) may be brought to reaction by radiation and/or thermally. Preference is given to thermally crosslinkable groups (b).

Preference is given to thermally crosslinkable groups (b) in the crosslinker (V) which react with the preferred functional groups (a), selected from the group consisting of hydroxyl, amino and/or epoxy groups. Particularly preferred complementary groups (b) are selected from the group of the carboxyl groups, the nonblocked or blocked polyisocyanate groups, the carbamate groups and/or the methylol groups, which if desired have been wholly or partly etherified with alcohols.

Very particular preference is given to functional complementary groups (b) in the crosslinker (V) which react with the particularly preferred hydroxyl groups as functional groups (a), with (b) preferably being selected from the group of the nonblocked or blocked polyisocyanate groups and/or of the methylol groups, which if desired have been wholly or partly etherified with alcohols.

In the coating material, the crosslinking agent (V) is present preferably in fractions of 5% to 60% by weight, preferably of 10% to 50% by weight, based on the nonvolatile fractions of the coating material.

In a preferred embodiment of the invention, the crosslinking agent V is selected from the group of the water-dispersible crosslinking agents (WV). To prepare such water-dispersible crosslinking agents (WV), the above-described groups capable of forming anions are preferably incorporated into the crosslinker molecules and, after they have been neutralized, ensure that the crosslinking agent (WV) can be dispersed stably in water. Suitable groups capable of forming anions are preferably carboxyl, sulfonic acid and phosphonic acid groups, more preferably carboxyl groups. To neutralize the groups capable of forming anions, preference is likewise given to using the ammonia, amines and/or amino alcohols described above in the amounts described above.

Examples of polyisocyanates and suitable blocking agents suitable as preferred crosslinking agents (V) are described in, for example, EP-A-1 192 200, the blocking agents more particularly having the function of preventing unwanted reaction of the isocyanate groups with the reactive groups (a) of the polymer (P1) and/or (P2) or (WP1) and/or (WP2) used for the method of the invention and also with further reactive groups and with the water in the coating material, both before and during application. The blocking agents are selected such that the blocked ioscyanate groups undergo deblocking again only in the temperature range in which the thermal crosslinking of the coating material is to take place, more particularly in the temperature range between 120 and 180 degrees C., and then enter into crosslinking reactions with the functional groups (a). Particularly preferred polyisocyanates as crosslinking agents (V) are selected from the group of the water-dispersible polyisocyanates (WV), which are obtained by reacting polyisocyanates, preferably hexamethylene diisocyanate or isophorone diisocyanate trimerized to form isocyanurate, compounds capable of forming anions, preferably 2,2-bis(hydroxymethyl)propionic acid, and the blocking agent, preferably 3,5-dimethylpyrazole, diethyl malonate or oximes, more preferably butanone oxime. The molar ratio of polyisocyanate, preferably trimerized diisocyanate, to the compound capable of forming anions, preferably 2,2-bis(hydroxymethyl)propionic acid, is preferably between 1:1 and 2:1, more preferably between 1.1:1 and 1.5:1.

Examples of components containing methylol groups suitable as preferred crosslinkers (V) are more particularly water-dispersible amino resins (WV), of the kind described in, for example, EP-A-1 192 200. Preference is given to using amino resins, more particularly melamine-formaldehyde resins, which react in the temperature range between 100 and 180 degrees C., preferably between 120 and 160 degrees C., with the functional groups (a), more particularly with hydroxyl groups. Particularly preferred amino resins as crosslinking agents (V) or (WV) are selected from the group of hexamethoxymethylmelamine-formaldehyde resins.

In a very particularly preferred embodiment of the invention, the crosslinking agents (V) and/or (WV) used are combinations of the aforementioned blocked polyisocyanates with the aforementioned amino resins. The mixing ratio of the blocked polyisocyanates to the amino resins is preferably between 4:1 and 1:4, more preferably between 3:1 and 1:3 (ratio of the nonvolatile fractions of the two components).

Incorporated in the coating material used for the method of the invention are preferably 0.1% to 30% by weight, more preferably between 0.5% and 25% by weight, most preferably between 1% and 20% by weight, based on the nonvolatile fractions of the coating material, of anisotropic particles (T) whose average particle diameter (D), which corresponds in the case of non-circular particles to the particle diameter of the longest area diagonal of the particle, D is <1 μm and whose D/d ratio of the average particle diameter (D) to the average particle thickness (d) is >50, preferably D/d>100, more preferably D/d>200. The average particle diameters can be determined via evaluation of TEM (transmission electron microscope) graphs, while the particle thicknesses (d) are determined experimentally by way of x-ray structural analysis, profile measurements by means of AFM (atomic force microscopy) on individual platelets, and also arithmetically, with knowledge of the molecular structure. The average particle diameter (D) of the anisotropic particles (T) is preferably between 50 and 800 nm, more preferably between 100 and 500 nm; the particle thickness (d) is preferably between 0.1 and 1.0 nm, more preferably between 0.15 and 0.75 nm.

A number and mobility of the particles required for the control of the phase morphology can be established with the aforementioned particles according to whether they are distributed into the organic matrix as individual particles dispersed in the matrix (exfoliated state), as individually dispersed stacks with individual particles arranged in a plane-parallel manner, comprising polymeric matrix material between the individual particles (intercalated state), or as individually dispersed agglomerates of stacks of the individual particles.

In a preferred embodiment of the invention, the anisotropic particles (T) consist at least partly of inorganic particles (AT). In a further preferred embodiment of the invention, the anisotropic particles (T) are electrically charged.

Typically the interlayer spacings, determined by x-ray diffraction, between the electrically charged inorganic particles are specified. The interlayer spacing encompasses the sum of the layer thickness (d) of a particle and the spacing between two such particles. The latter spacing is dependent on the nature of the counterions present in the particle, which neutralize the electrical charge carriers of the particles, and also on the presence of electrically neutral molecules having a swelling action, such as water or organic solvents. Thus it is known, for example, that the interlayer spacing in montmorillonite varies between 0.97 and 1.5 nm as a function of the water content of the usually naturally occurring ambient conditions (J. Phys. Chem. B, 108 (2004), 1255).

In one embodiment of the invention, the preferably electrically charged inorganic particles (AT) can be produced by swapping the naturally present or as-synthesized counterions of the layer like minerals for the inorganic and/or organic counterions (GI), in accordance with methods that are known per se. For this purpose, for example, the electrically charged inorganic particles (AT) are suspended in a suitable liquid medium, which is capable of swelling the interstices between the individual layers, and in which the inorganic and/or organic counterions (GI) are in solution, and subsequently isolating them again (Langmuir 21 (2005), 8675).

When ionic exchange takes place, preferably more than 15 mol %, more preferably more than 30 mol %, of the counterions from the synthesis are replaced by the inorganic and/or organic counterions (GI). Depending on the size and the spatial orientation of the counterions (GI), the layer structures are generally widened, with the distance between the electrically charged layers (interlayer spacing) being widened preferably by at least 0.2 nm, more preferably by at least 0.5 nm.

The inorganic and/or organic counterions (GI) used for at least partial compensation of the charge and for distancing of the layers of the inorganic particles (AT) have the following construction: acting as charge carriers are, preferably, cationic and/or anionic groups, such as, in the case of organic counterions (GI), as cations, preferably alkyl-substituted sulfonium and/or phosphonium ions, which preferably do not give rise to any discoloration of the inventively produced coat when that coat is cured, and also, in the case of organic counterions (GI), as anions, preferably anions of carboxylic acids, of sulfonic acids and/or of phosphonic acids. In the case of inorganic counterions (GI), the cations which function as charge carriers are preferably alkali metal and alkaline earth metal anions, and the anions are preferably anions of mineral acids, which likewise preferably do not cause any discoloration of the coat in the course of curing of the coat produced in accordance with the invention.

Examples of substances suitable for preparing the inorganic particles (AT) include clay minerals, such as, more particularly, naturally occurring smectite types, such as montmorillonite, saponite, hectorite, fluorohectorite, beidellite, nontronite, vermiculite, halloysite and stephanite, or synthesized smectite types, such as Laponite or SOMASIF (synthetic fluorinated sheet silicate from CO—OP Chemical Co., Japan). The aforementioned minerals have a negative surface charge, which is compensated by the positively charged, inorganic and/or organic counterions (GI).

Particularly preferred for the purposes of the invention are catalytically charged inorganic particles (AT), such as, more particularly, the mixed hydroxides of the formula:

(M₍₁₋ₓ₎²⁺Mₓ³⁺(OH)₂)(A_{x/y}^{y-})⁻nH₂O

where M²⁺ represents divalent cations, M³⁺ represents trivalent cations, and (A) represents anions having a valence y, with x adopting a value of 0.05 to 0.5.

Particularly preferred divalent cations M²⁺ are calcium, zinc and/or magnesium ions, and/or particularly preferred trivalent cations M³⁺ are aluminum ions, and particularly preferred anions (A) are phosphate ions, sulfate ions and/or carbonate ions, since these ions go a long way to ensuring that there is no change in shade when the inventive coat is cured. The synthesis of the mixed oxides is known (E. Kanezaki, Preparation of Layered Double Hydroxides in Interface Science and Technology, vol. 1, chapter 12, page 345 ff—Elsevier, 2004, ISBN 0-12-088439-9). The synthesis usually takes place from the mixtures of the salts of the cations in aqueous phase at defined, basic pH levels which are kept constant. The products are the mixed hydroxides containing the anions of the metal salts as inorganic counterions intercalating into the interstices. Where the synthesis takes place in the presence of carbon dioxide, the product is generally the mixed hydroxide with intercalating carbonate ions. If the synthesis is carried out in the absence of carbon dioxide or carbonate but in the presence of organic anions or their acidic precursors, the product is generally the mixed hydroxide with organic anions intercalating into the interstices (coprecipitation method or template method). An alternative synthesis route for the preparation of the mixed hydroxides is the hydrolysis of the metal alkoxides in the presence of the desired anions for intercalation (U.S. Pat. No. 6,514,473).

In a further embodiment of the invention, it is possible to introduce the inorganic and/or organic anions for intercalation as counterions (GI) by means of ion exchange in mixed hydroxides with intercalated carbonate ions. This can be done, for example, especially when preparing hydrotalcites and hydrocalumites, by rehydrating the amorphous calcined mixed oxide in the presence of the desired anions for intercalation. Calcining the mixed hydroxide containing intercalated carbonate ions at temperatures <800 degrees C. yields the amorphous mixed oxide, with retention of the layer structures.

Alternatively the ion exchange may take place in an aqueous or aqueous-alcoholic medium in the presence of the acidic precursors of the organic anions for intercalation. In this case, depending on the acid strength of the precursor of the inorganic and/or organic anion for intercalation as counterion (GI), treatment with dilute mineral acids is needed in order to remove the carbonate ions.

The organic anions used as counterions (GI) in one embodiment of the invention for at least partial compensation of the charge and for distancing of the layers of the aforementioned mixed hydroxides are preferably singly charged. The charge carriers used are preferably anionic groups (AG), more preferably anions of the carboxylic acid, of the sulfonic acid and/or of the phosphonic acid.

In a further preferred embodiment of the invention the organic anions additionally carry, as counterions (GI), functional groups (c) which, when the coating material is cured, react with the functional groups (a) of the binder BM and/or with the functional groups (b) of the crosslinker, with formation of covalent bonds. The groups (c) may be radiation-curable and/or thermally curable. Preference is given to thermally curable groups (c), of the kind indicated above in the context of the description of groups (a) and (b). More preferably the functional groups (c) are selected from the group consisting of hydroxyl, epoxy and/or amino groups.

The functional groups (c) are preferably separated from the anionic groups of the organic anions as counterions (GI) by a spacer (SP), with (SP) being selected from the group consisting of unsubstituted and substituted aliphatics and/or cycloaliphatics which if desired are modified with heteroatoms, such as nitrogen, oxygen and/or sulfur, and which have a total of 3 to 30 carbon atoms, preferably between 4 and 20 carbon atoms, more preferably between 5 and 15 carbon atoms; unsubstituted and substituted aromatics which if desired are modified with heteroatoms, such as nitrogen, oxygen and/or sulfur, and which have a total of 3 to 20 carbon atoms, preferably between 4 and 18 carbon atoms, more preferably between 5 and 15 carbon atoms; and/or substructures of the above-recited cycloaliphatics and aromatics, the substructures more particularly containing at least 3 carbon atoms and/or heteroatoms between the functional group (c) and the anionic group (AG).

More preferably the spacers (SP) of the organic anions as counterions (GI) are unsubstituted or substituted phenyl or cyclohexyl radicals which have the functional group (c) positioned m or p to the anionic group (AG). In this case use is made in particular of hydroxyl and/or amino groups as functional group (c) and of carboxylate and/or sulfonate groups as anionic group (AG).

Very particularly preferred organic anions as counterions (GI) are m- or p-aminobenzenesulfonate, m- or p-hydroxybenzenesulfonate, m- or p-aminobenzoate and/or m- or p-hydroxybenzoate.

In the abovementioned, particularly preferred mixed hydroxides which from their synthesis preferably contain carbonate as anion (A) the ion exchange replaces preferably more than 15 mol %, more preferably more than 30 mol %, of the anions (A) by the organic anions as counterions (GI).

The modification of the cationically charged inorganic particles (AT) is preferably carried out in a separate process prior to incorporation into the coating material of the invention, this process being carried out with particular preference in an aqueous medium. The electrically charged inorganic particles (AT) modified with the organic counterions are preferably prepared in one synthesis step. The particles thus prepared have only a very slight inherent color, and preferably are colorless. The preferred cationically charged particles modified with inorganic anions as counterions (GI) can be prepared in one synthesis step more particularly from the metal salts of the cations and from the organic ions. In this case, preferably, an aqueous mixture of salts of the divalent cations M²⁺ and of the trivalent cations M³⁺ is introduced into an aqueous alkaline solution of the organic anions as counterions (GI) until the desired stoichiometry has been established. The addition takes place preferably under a CO₂-free atmosphere, under nitrogen, for example, and with stirring at temperatures between 10 and 100 degrees C., more preferably at room temperature, with the pH of the aqueous reaction mixture being kept in the range from 8 to 12, preferably between 9 and 11, by the addition, preferably, of alkaline hydroxides, more preferably NaOH. Following addition of the aqueous mixture of the metal salts, the resulting suspension is aged at the aforementioned temperatures for a time of 0.1 to 10 days, preferably 3 to 24 hours, the resulting precipitate is isolated, preferably by centrifugation, and the isolated precipitate is washed repeatedly with deionized water. Thereafter, from the purified precipitate, a suspension is established of the cationically charged particles (AT) modified with the organic anions as counterions (GI), having a solids content of 5% to 50% by weight, preferably of 10% to 40% by weight.

The crystallinity of the resulting layered double hydroxides is dependent on the selected synthesis parameters, on the nature of the cations employed, on the ratio of the M²⁺/M³⁺ cations, and on the nature and the amount of the anions employed, and ought to adopt values which are as large as possible.

The crystallinity of the mixed hydroxide phase can be expressed as the calculated size of the coherent scattering domains from the analysis of the corresponding x-ray diffraction lines, examples being the [003] and [110] reflections in the case of the MgAl hydrotalcite. Thus, for example, Eliseev et al. (Doklady Chemistry 387 (2002), 777) show the effect of thermal aging on the growth of the domain size of the MgAl hydrotalcite investigated, and explain this by the progressive incorporation of extant tetrahedrally coordinated aluminum into the mixed hydroxide layer in the form of octahedrally coordinated aluminum, shown via the relative intensities of the corresponding signals in the ²⁷Al—NMR spectrum.

The anisotropic particles (T) or the above-described suspensions of the electrically charged inorganic particles (AT) may, in the method according to the invention for producing the coating material, in principle be incorporated during any phase, i.e. before, during and/or after the addition of the other components of the coating material.

In addition to the aforementioned components essential to the invention, the coating material used in the method according to the invention may also comprise further, optionally water-dispersible binders in proportions of up to 40% by weight, preferably of up to 30% by weight and more preferably of up to 20% by weight, based on the nonvolatile constituents of the coating material.

The coating material used in the method according to the invention may also comprise customary coatings additives in effective amounts. For example, color and effect pigments in customary and known amounts may be part of the coating material. The pigments may consist of organic or inorganic compounds and are listed by way of example in EP-A-1 192 200. Further usable additives are, for example, UV absorbers, free-radical scavengers, slip additives, polymerization inhibitors, defoamers, emulsifiers, wetting agents, leveling agents, film-forming assistants, rheology control additives and preferably catalysts for the reaction of the functional groups a, b and/or c, and additional crosslinking agents for the functional groups a, b and/or c. Further examples of suitable coatings additives are described, for example, in the textbook “Lackadditive” [Additives for coatings] by Johan Bieleman, publisher: Wiley-VCH, Weinheim, New York, 1998.

The aforementioned additives are present in the inventive coating material preferably in proportions of up to 40% by weight, preferably up to 30% by weight and more preferably of up to 20% by weight, based on the nonvolatile constituents of the coating material.

The preferably aqueous coating materials used in the method according to the invention are preferably prepared by first mixing all of the constituents of the coating material apart from the anisotropic particles (T) and the preferably used amino resin component of the crosslinking agent (V) or (WV). The suspension of the electrically charged inorganic particles (AT) optionally modified with the organic counterions (OG) as prepared, preferably, by the process recited above is introduced into the resulting mixture with stirring, until the suspension has undergone full dissolution, which can be monitored by optical methods, more particularly by visual inspection.

The resulting mixture is treated preferably at temperatures between 10 and 50 degrees C. for a time of 2 to 30 minutes, preferably of 5 to 20 minutes, preferably at room temperature, with ultrasound, while stirring; in one particularly preferred embodiment, the tip of an ultrasound source is immersed into the mixture. During the ultrasound treatment the temperature of the mixture may rise by 10 to 60 K. The dispersion thus obtained is preferably aged at room temperature for at least 12 hours with stirring. Thereafter the crosslinker (V) or (WV) is added, with stirring, and the dispersion is adjusted, preferably with water, to a solids content of 15% to 50% by weight, preferably 20% to 40% by weight.

The invention provides a method of establishing defined morphologies of separated phases in thin coats, in which anisotropic particles (T) whose average particle diameter (D) is <1 μm and whose D/d ratio of the average particle diameter (D) to the average particle thickness (d) is >50 are introduced into the coating material that is described above for producing said coats and that comprises at least one polymer (P1), at least one polymer (P2) which is incompatible with polymer (P1) in the solid phase, where the polymers (P1) and/or (P2) have at least one functional group (a) which reacts in the course of curing of the coating material to form covalent bonds, the coating material is applied to an uncoated substrate and/or to a precoated substrate and then cured.

For the control of the morphology of the separated phases in thin coats, preference is given to a difference in the affinity of the anisotropic particles (T) for the incompatible polymers (P1), (P2) and/or for the crosslinking agent (V). In a particularly preferred embodiment of the invention, at least one component from the group of (P1), (P2) and (V) has a difference in hydrophilicity compared to the other components, which is preferably established via a suitable selection of the units of the above-described polymers (P1) or (WP1), (P2) or (WP2), and of the crosslinker (V) or (WV). In a very particularly preferred embodiment of the invention, the polymer (P1) or (WP1) is set at a higher level of hydrophobicity than the polymer (P2) or (WP2) and/or the crosslinking agent (V) or (WV), particularly preferred polymers (P1) or (WP1) being polyurethanes, particularly preferred polymers (P2) or (WP2) being polyesters, and particularly preferred crosslinking agents (V) or (VW) being polyisocyanates and/or amino resins. Depending on their surface properties, the anisotropic particles (T) accumulate in the more hydrophilic or in the more hydrophobic phase.

The surface properties of the anisotropic particles (T) are preferably controlled via the ion exchange capacity of the anisotropic particles (T) and/or through the selection of the counterions (GI) in the above-described preferred electrically charged anisotropic particles (T). The ion exchange capacity is, for example, in the preferred mixed hydroxides, adjusted through the ratio of divalent to trivalent cations, which is more preferably between 1:1 and 4:1.

Moreover, small, preferably inorganic counterions (GI) with a high charge density, more preferably ammonium, alkali metal or alkaline earth metal ions as cations, and more preferably phosphate ions, sulfate ions or carbonate ions as anions, bring about the formation of a hydrophilic surface of the preferred inorganic anisotropic particles (AT) and thus bring about a greater affinity for the more hydrophilic phase. Relatively large, preferably organic counterions (GI) with a comparatively low charge density, more preferably tetraalkylammonium ions, trialkylsulfonium ions or tetraalkylphosphonium ions as cations, and more preferably organic anions of the carboxylic acid, of the sulfonic acid and/or of the phosphonic acid, especially the above-described organic counterions, which are used to modify the particularly preferred cationically charged inorganic anisotropic particles (AT), generally bring about the formation of a hydrophobic surface and hence a greater affinity for the more hydrophobic phase.

By virtue of suitable selection of the mixing ratio of the more hydrophilic component, preferably formed from the polymer (P2) or (WP2) and/or the crosslinking agent (V) or (WV), to the more hydrophobic component, preferably formed from the polymer (P1) or (WP1), and by virtue of suitable selection of anisotropic particles (T) with a hydrophilic or hydrophobic surface, it is possible to produce, in thin coats, disperse structures, bicontinuous structures or structures stratified macroscopically in two coats. In a preferred embodiment of the invention, a mixing ratio of hydrophilic components to hydrophobic components of 10:1 to 0.2:1, more preferably of 6:1 to 1:1, is selected. In the case of addition of electrically charged particles, preferably of cationically charged inorganic anisotropic particles (AT), more preferably of mixed hydroxides of the aforementioned formula, in combination with anions as counterions (GI) with a high charge density, especially with carbonate anions, the result, after the curing of the coating material, is bicontinuous structures or structures stratified macroscopically in two coats, while, in the case of combination of the cationically charged inorganic anisotropic particles (AT), more preferably mixed hydroxides of the aforementioned formula with anions as counterions (GI) with a relatively low charge density, especially with m- or p-aminobenzene-sulfonate, m- or p-hydroxybenzenesulfonate, m- or p-aminobenzoate and/or m- or p-hydroxybenzoate, the result is disperse or bicontinuous structures.

What is common to all structures produced in this way is that they have a significantly improved damage pattern compared to the prior art, especially with regard to the reduction of delamination of the layer and with regard to the proportion of the completely eroded layer after impact exposure.

In the method according to the invention, the inventive coating materials are preferably applied in such a wet film thickness as to result, after curing, in the finished layers, in a dry film thickness between 1 and 100 μm, preferably between 5 and 75 μm, more preferably between 10 and 60 μm, especially between 15 and 50 μm.

The application of the coating material in the method of the invention can be accomplished by means of typical application methods, such as spraying, knife coating, spreading, pouring, dipping or rolling, for example. It is preferred to employ spray application methods, such as compressed-air spraying, airless spraying, high-speed rotational spraying, and electrostatic spray application (ESTA), for example. Application is carried out generally at temperatures of not more than 70 to 80 degrees C., thereby allowing suitable application viscosities to be attained without the brief thermal exposure being accompanied by change or damage to the coating material or to its overspray, which if appropriate can be reprocessed.

The radiation curing of the film applied in accordance with the method of the invention comprising a coating material with radiation-crosslinkable groups takes place with actinic radiation, more particularly with UV radiation, preferably in an inert atmosphere, as described in WO-A-03/016413, for example.

The preferred thermal curing of the film applied in the method of the invention comprising the preferred coating material with thermally crosslinkable groups takes place by the known methods, as, for example, by heating in a forced-air oven or by irradiation using infrared lamps. Advantageously the thermal cure takes place at temperatures between 100 and 180 degrees C., preferably between 120 and 160 degrees C., for a time of between 1 minute and 2 hours, preferably between 2 minutes and 1 hour, more preferably between 3 and 30 minutes. Where substrates are used, such as metals, for example, which have the capacity to withstand a high thermal load, the cure may also be carried out at temperatures above 180 degrees C. Generally speaking, however, it is advisable not to exceed temperatures of 160 to 180 degrees C. Where, on the other hand, substrates such as plastics, for example, are used which have a maximum limit to their ability to withstand thermal loads, the temperature and the time needed for the curing operation must be brought into line with this maximum limit.

In the context of the present invention, it has also been found that the exposed substrate surface area after impact exposure of substrates coated with OEM coat systems can be reduced considerably when at least one layer of the OEM coat system is produced by the above-described method. Very particular preference is given to the use of the method according to the invention for producing surfacer coats which, after impact exposure, have a significantly reduced exposure of the substrate surface. Especially in classical structures for OEM line finishing, in which a multilayer structure consisting, viewed from the substrate, of an electrolytically deposited layer, preferably of a cathodically deposited layer, of a surfacer coat and of a final topcoat, preferably consisting of a basecoat and of a final clearcoat, is applied on the metallic substrate and/or a plastic substrate, the surfacer coats produced by the method according to the invention are particularly advantageous.

In a further preferred embodiment of the invention, a final topcoat is applied to the surfacer coat produced by the method according to the invention, preferably first a basecoat and finally a clearcoat in two further stages. In this case, in one particularly preferred method, first the film of the invention is applied and cured by the method of the invention and then, preferably in a first step, an aqueous basecoat material is applied and, after a flash for a time between 1 to 30 minutes, preferably between 2 and 20 minutes, at temperatures between 40 and 90 degrees C., preferably between 50 and 85 degrees C., and in a second step, the basecoat film is overcoated with a clearcoat material, preferably a two-component clearcoat material, and basecoat and clearcoat are cured jointly. In a further preferred embodiment of the invention the surfacer film produced with the method of the invention is flashed prior to application of the basecoat film, for a time between 1 to 30 minutes, preferably between 2 and 20 minutes, at temperatures between 40 and 90 degrees C., preferably between 50 and 85 degrees C. Thereafter, surfacer film, basecoat film, and clearcoat film are jointly cured.

The coatings produced by the process according to the invention, especially the OEM paint structures consisting, viewed from the substrate, of an electrolytically deposited anticorrosion layer, of the surfacer coat produced with the inventive coating material and of a final topcoat, preferably composed of a colored basecoat and a final clearcoat, exhibit excellent resistance to impact stress, more particularly to stonechipping. Compared to surfacers customary on the market and compared to separated systems, in particular, a reduction is observed in particular in the fraction of the surface that is damaged, and a very significant reduction in the fraction of the surface that is completely worn away, in other words the fractional area of the unprotected metal substrate. In addition to these outstanding properties, the coatings produced with the coating materials of the invention exhibit excellent condensation resistance, excellent adhesion to the anticorrosion coat and to the basecoat, and excellent stability of the inherent color after curing. Moreover, with the coating material of the invention, surfacer coats can be realized which have a comparatively low baking temperature and a good topcoat appearance.

The examples which follow are intended to illustrate the invention.

### EXAMPLES

### Preparation Example 1

### Synthesis of the Aqueous Dispersion of a Polyester (Hydrophilic Component WP2)

A reactor with an anchor stirrer, nitrogen inlet, reflux condenser and distillation system is initially charged with 14.320 g of 1,6-hexanediol, 3.794 g of trimethylolpropane, 7.193 g of isophthalic acid, 4.507 g of adipic acid, 2.752 g of phthalic acid and 0.669 g of xylene. The reaction mixture is blanketed with nitrogen and heated to 230 degrees C. with stirring. The water of reaction is removed until the reaction mixture has an acid number to DIN EN ISO 3682 of less than 4 mg KOH/g and a viscosity between 11 and 17 dPas (measured at 50 degrees C. with a cone-and-plate viscometer from ICI). Thereafter, the xylene is removed by distillation and the reaction mixture is cooled to 120 degrees C. Thereafter, 5.910 g of trimellitic anhydride are added, the reaction mixture is heated to 170 degrees C. and the temperature is maintained until the reaction mixture has an acid number between 53 and 56 mg KOH/g and a viscosity between 390 and 630 mPas (measured at 120 degrees C. with a cone-and-plate viscometer from ICI). The resulting polyester has an acid number to DIN EN ISO 3682 of 60 mg KOH/g and an OH number to DIN EN ISO 4629 of 140.

The reaction mixture is cooled to 120 degrees C., and 2.127 g of dimethylethanolamine are added. The reaction mixture is then cooled to 95 degrees C.

The polyester is taken up in 57.862 g of water, in the course of which the pH is adjusted to from 7.2 to 7.6 by adding further dimethylethanolamine. The resulting dispersion of the polyester has a solids content of 36% by weight.

### Preparation Example 2

### Synthesis of the Aqueous Dispersion of a Polyurethane (Hydrophobic Component WP1)

Synthesis of the Polyester Precursor:

A reactor with an anchor stirrer, nitrogen inlet, reflux condenser and distillation system is initially charged with 30 g of 1,6-hexanediol, 16 g of isophthalic acid, 54 g of dimer fatty acid (Pripol 1012 from Uniqema) and 0.9 g of xylene. The reaction mixture is blanketed with nitrogen and heated to 230 degrees C. with stirring. The water of reaction is removed until the reaction mixture has an acid number to DIN EN ISO 3682 of less than 4 mg KOH/g and a viscosity between 11 and 17 dPas (measured at 50 degrees C. with a cone-and-plate viscometer from ICI). Thereafter, the xylene is removed by distillation and the reaction mixture is cooled to 50 degrees C.

The resulting polyester is taken up in 34.5 g of methyl ethyl ketone. The resulting dispersion of the polyester has a solids content of 36% by weight.

Synthesis of the Polyurethane Dispersion:

A reactor with an anchor stirrer, nitrogen inlet and reflux condenser is initially charged with 21.386 g of the polyester precursor, 0.289 g of neopentyl glycol, 1.396 g of dimethylolpropionic acid, 7.529 g of methylenebis(4-isocyanatocyclohexane) and 2.502 g of methyl ethyl ketone. The reaction mixture is blanketed with nitrogen and heated to 85 degrees C. with stirring until a 1:1 dilution of the reaction product with N-methylpyrrolidone has an isocyanate content of 0.9 to 1.2% by weight and a viscosity between 6 and 7 dPas (measured at 23 degrees C. with a cone-and-plate viscometer from ICI).

Thereafter, 0.784 g of trimethylolpropane is added and the reaction mixture under nitrogen is heated to 85 degrees C. with stirring until a 1:1 dilution of the reaction product with N-methylpyrrolidone has an isocyanate content of less than 0.3% by weight and a viscosity between 12 and 13 dPas (measured at 23 degrees C. with a cone-and-plate viscometer from ICI). The resulting polyurethane has an acid number to DIN EN ISO 3682 of 30 mg KOH/g and an OH number to DIN EN ISO 4629 of 20.

The resulting polyurethane is taken up in 5.763 g of butylglycol, and 0.537 g of dimethylethanolamine is added.

The polyurethane is taken up in 50 g of water at a constant temperature of 80 degrees C., and then the methyl ethyl ketone is removed down to a residual content of less than 0.4% by weight by distillation. The resulting dispersion of the polyurethane is adjusted to a pH of 7.2 to 7.4 by adding further dimethylethanolamine and water. The dispersion of the polyurethane has a solids content of 31% by weight.

### Preparation Example 3

### Synthesis of the Aqueous Dispersion of the Blocked Polyisocyanate (Hydrophilic Component WV)

A reactor with an anchor stirrer, nitrogen inlet and reflux condenser is initially charged with 26.032 g of trimerized hexamethylene diisocyanate (Desmodur 3300 from Bayer) and 8.5 g of N-methylpyrrolidone. 7.891 g of methyl ethyl ketoxime are added to the solution. The reaction mixture is blanketed with nitrogen and kept at 70° C. with stirring until an NCO equivalent weight of 890 to 1060 daltons has been attained.

Thereafter, 6.077 g of dimethylpropionic acid are added and the reaction mixture is kept under nitrogen with stirring at 70 degrees C. until an NCO equivalent weight of more than 21 000 daltons has been attained and a 1:1 dilution of the reaction product with N-methylpyrrolidone has a viscosity between 4.2 and 5.2 dPas (measured at 23 degrees C. with a cone-and-plate viscometer from ICI). 1.5 g of butanol and 3.33 g of dimethylethanolamine are then added and the temperature is kept at 80 degrees C. over 1 hour.

The resulting blocked polyisocyanate is taken up in 44 g of water and the resulting dispersion of the blocked polyisocyanate is adjusted to a pH of 7.4 to 7.6 by adding further dimethylethanolamine and water. The dispersion of the blocked polyisocyanate has a solids content of 40% by weight.

### Preparation Example 4

### Synthesis of a Carbonate Ion-Containing Hydrotalcite Suspension Based on Mg/Al

An aqueous mixture of MgCl₂.6H₂O (1.64 molar) and AlCl₃.6H₂O (0.82 molar) is added at room temperature with constant stirring over 3 hours to an aqueous solution of Na₂CO₃ (0.16 molar), in the course of which the pH is kept constant at pH=9 by adding 3M NaOH solution, the amount of cations metered in being selected so as to result in a molar ratio of the carbonate counterion to the trivalent Al cation of 1:1. After the aqueous mixture of the metal salts has been added, the resulting suspension is aged at room temperature for 3 hours. The resultant precipitate is isolated by centrifugation and washed 4 times with deionized water.

The resulting suspension of the white reaction product Mg₂Al(OH)₆(CO₃)_{0.5}.2H₂O (hydrotalcite suspension) has a solids content of 14.7% by weight and a pH of 7.5.

### Preparation Example 5

### Synthesis of a Carbonate Ion-Containing Hydrotalcite Suspension Based on Zn/Al

An aqueous mixture of ZnCl₂.6H₂O (1.23 molar) and AlCl₃.6H₂O (0.61 molar) is added at room temperature with constant stirring over 3 hours to an aqueous solution of Na₂CO₃ (0.12 molar), in the course of which the pH is kept constant at pH=9 by adding 3M NaOH solution, the amount of cations metered in being selected so as to result in a molar ratio of the carbonate counterion to the trivalent Al cation of 1:1. After the aqueous mixture of the metal salts has been added, the resulting suspension is aged at room temperature for 3 hours. The resulting precipitate is isolated by centrifugation and washed 4 times with deionized water.

The resulting suspension of the white reaction product Zn₂Al(OH)₆(CO₃)_{0.5}.2H₂O (hydrotalcite suspension) has a solids content of 19.9% by weight and a pH of 7.0.

### Preparation example 6

### Synthesis of a 3-aminobenzenesulfonic Acid-Modified Hydrotalcite Suspension Based on Mg/Al

To a 0.21 molar aqueous solution of 3-aminobenzenesulfonic acid (3-absa) is added an aqueous mixture of MgCl₂.6H₂O (0.52 molar) and AlCl₃.6H₂O (0.26 molar) at room temperature under a nitrogen atmosphere with constant stirring over 3 hours, the amount of cations metered in being selected so as to result in a molar ratio of the 3-absa counterion to the trivalent Al cation of 4:1. In the course of this, the pH is kept constant at pH=10 by adding a 3 molar NaOH solution.

After the aqueous mixture of the metal salts has been added, the resulting suspension is aged at room temperature for 3 hours. The resulting precipitate is isolated by centrifugation and washed 4 times with deionized water.

The resulting suspension of the white reaction product Mg₂Al(OH)₆(3-absa).2H₂O (hydrotalcite suspension) has a solids content of 28.6% by weight and a pH of 9.4.

### Preparation Examples 7 to 10

### Formulation of the Coating Materials

In a first step, a dispersion of the mixture of the coating material components according to preparation examples 1 to 3 (amounts in table 1 below) is prepared at room temperature with stirring.

To this end, in preparation examples 8 to 10, the hydrotalcite suspensions prepared in examples 4 to 6 (amounts in table 1 below) are introduced at room temperature with stirring and stirred further for 12 hours until the hydrotalcite suspensions have dissolved completely (visual assessment).

The resulting dispersion is treated with ultrasound at room temperature with stirring for 15 minutes, in the course of which the tip of an ultrasound source (Sonotrode UP 100H from Hielscher GmbH) is held in the dispersion and the amplitude and pulse rate are each set to 100% at a working frequency of 30 kHz. During the ultrasound treatment, the temperature of the dispersion rises to 65 degrees C. The resulting dispersion is aged for 12 hours.

In comparative example 7, a dispersion of the mixture of the coating material components according to preparation examples 1 to 3 (amounts in table 1 below) is prepared at room temperature with stirring and treated with ultrasound according to examples 8 to 10.

Thereafter, the dispersions are admixed with melamine-formaldehyde resin (Maprenal MF 900 from Ineos Melamines GmbH) (amounts in table 1 below) with stirring at room temperature.

TABLE 1
Composition of the coating materials according
to preparation examples 7 to 10

| Preparation example | 7 | 8 | 9 | 10 |
|---|---|---|---|---|
| Composition of the coating | | | | |
| material (part by weight) | | | | |
| Polyester (PES) dispersion | 55.55 | 55.55 | 55.55 | 55.55 |
| according to preparation example 1 | | | | |
| Polyurethane (PUR) dispersion | 27.77 | 27.77 | 27.77 | 27.77 |
| according to preparation example 2 | | | | |
| Isocyanate (P-NCO) dispersion | 16.66 | 16.66 | 16.66 | 16.66 |
| according to preparation example 3 | | | | |
| Melamine-formaldehyde resin | 10.1 | 9.10 | 9.50 | 9.70 |
| Hydrotalcite suspension | — | 17.50 | — | — |
| according to preparation example 4 | | | | |
| Hydrotalcite suspension | — | — | 12.30 | — |
| according to preparation example 5 | | | | |
| Hydrotalcite suspension | — | — | — | 15.00 |
| according to preparation example 6 | | | | |
| Nonvolatile constituents | | | | |
| (parts by weight) | | | | |
| PES | 45.2 | 43.7 | 43.4 | 41.7 |
| PUR | 18.3 | 17.7 | 17.6 | 16.9 |
| P-NCO | 14.7 | 14.2 | 14.1 | 13.5 |
| Melamine-formaldehyde resin | 21.8 | 19.0 | 19.7 | 19.3 |
| Hydrotalcite (incl. counterions) | 0 | 5.5 | 5.2 | 8.7 |
| Hydrotalcite (excl. counterions) | 0 | 4 | 4 | 4 |

### Examples 11 to 14

### Production of OEM Coat Systems with Coating Materials According to Preparation Examples 7 to 10 and Testing of the Stonechip Resistance

The inventive coating materials prepared according to preparation examples 7 (comparative) and 8 to 10 are applied by means of spraying (automatic-coater from Köhne) to pretreated steel panels precoated with a cathodic electrocoat material (steel panels from Chemetall: thickness of the baked cathodic electrocoat: 21+/−2 μm, thickness of the substrate: 750 μm). The resulting films of the coating materials are cured at 140 degrees C. for 20 minutes, giving dry film thicknesses of 30+/−3 μm.

Continuing, an OEM coat system is produced on the panels thus precoated by applying, in separate steps, first a commercial aqueous basecoat material (FV95-9108 from BASF Coatings AG), which is flashed at 80 degrees C. for 10 minutes, and, lastly, a 2-components solventborne clearcoat material (FF95-0118 from BASF Coatings AG). The aqueous basecoat film and the clearcoat film are cured jointly at 140 degrees C. for 20 minutes, after which the basecoat has a dry film thickness of approx. 15 μm and the clearcoat has a dry film thickness of 45 μm.

The panels thus coated are stored for 3 days at 23 degrees C. and 50% relative air humidity.

The morphology of the surfacer coats in the OEM coat system was analyzed and characterized by means of optical microscopy (table 2).

Testing of the Stonechip Resistance:

The coated steel panels produced as described above are subjected to a DIN 55996-1 stonechip test, using 500 g each time of cooled iron granules (4 to 5 mm particle diameter, from Würth, Bad Friedrichshall) and setting an air pressure of 2 bar on the bombardment apparatus (model 508 VDA from Erichsen).

After the test panels damaged in this way have been cleaned, they are immersed into a solution of an acidic copper salt, and elemental copper is deposited on those areas of the steel substrate at which bombardment had removed the coating completely.

The damaged pattern over 10 cm² of each of the damaged and aftertreated test panels is captured using image processing software (SIS-Analyse). Evaluations are made of the fractions of surfaces damaged by bombardment, and of the fractions of surfaces completely worn away, based in each case on the total surface area. Table 2 sets out the results.

TABLE 2
Damage patterns of the coat systems produced with the coating
material of the invention and with the reference surfacer

| | Examples | | | |
|---|---|---|---|---|
| | 11 | | | |
| | (comparative) | 12 | 13 | 14 |
| Coating material | 7 | 8 | 9 | 10 |
| according to example | | | | |
| Fraction of surface | 0.9 | 0.06 | 0.15 | 0.25 |
| completely worn away | | | | |
| (area %) | | | | |
| Total damaged surface | 5.0 | 3.4 | 3.6 | 5.5 |
| area (area %) | | | | |
| Morphology of the | disperse | bicon- | stratified in | disperse |
| layer | | tinuous | two layers | |

The coating materials comprising the more hydrophilic carbonate ion-containing hydrotalcites (examples 12 and 13) have, after curing, a bicontinuous phase structure or a structure stratified macroscopically in two coats, while the coating material comprising the more hydrophobic hydrotalcites modified with organic counterions (example 14) has a disperse phase structure after curing.

Compared to the coat system (example 11) produced with the comparative surfacer (preparation example 7), which also has a disperse phase morphology, the coat systems produced with the inventive coating material as surfacer material have a very significant reduction in the fraction of the surface completely worn away, i.e. the area fraction of the unprotected metal substrate.

The adhesion to the coat of the cathodic electrocoat and to the basecoat are likewise excellent, which is reflected in an unchanged or reduced total damage to the surfaces within the error limits of +/−0.5.

The coatings produced with the coating material of the invention, moreover, feature excellent condensation resistance and a virtually unchanged inherent color after baking.

1. A method of establishing defined morphologies of separated phases in a thin coats, which comprises
introducing anisotropic particles (T) into a coating material, the anisotropic particles (T) having an average particle diameter (D) that is <1 μm and a D/d ratio of the average particle diameter (D) to an average particle thickness (d) that is >50, wherein the coating material comprises at least one polymer (P1), at least one polymer (P2) incompatible with the polymer (P1) in the solid phase and/or a crosslinking agent (V) incompatible with the polymer (P1) in the solid phase, where the polymers (P1) and/or (P2) have at least one functional group (a) which reacts in the course of curing of the coating material to form covalent bonds, and
applying the resulting coating material to an uncoated substrate and/or to a precoated substrate and then curing it to provide the thin coat.

2. The method of claim 1, wherein the anisotropic particles (T) comprise inorganic particles (AT).

3. The method of claim 1, wherein the anisotropic particles (T) are electrically charged.

4. The method of claim 1, wherein the polymer (P1), the polymer (P2), and/or the crosslinking agent (V) have Hildebrand solubility parameters δ(P1) of polymer (P1) and δ(P2) of polymer (P2) and/or δ(V) of the crosslinking agent (V) such that the magnitude of the difference is at least 1.

5. The method of claim 1, wherein the anisotropic particles (T), on introduction into the coating material, are in an aqueous suspension.

6. The method of claim 1, wherein the anisotropic particles (T) comprise at least one mixed hydroxide of the general formula
(M₍₁₋ₓ₎²⁺Mₓ³⁺(OH)₂)(A_{x/y}^{y-}).nH₂O
where M²⁺ represents divalent cations, M³⁺ represent trivalent cations, (A) represents anions having a valence y, and x is from 0.05 to 0.5.

7. The method of claim 1, wherein the crosslinking agent (V) comprises at least two crosslinkable functional groups (b), which when the coating material is cured react with the functional groups (a) to form covalent bonds.

8. The method of claim 7, wherein at least one of components (P1), (P2) and (V) has a different hydrophilicity compared to the other components.

9. The method of claim 1, wherein the coating material has an aqueous phase and at least one of the polymer (P1), the polymer (P2), or the crosslinking agent (V) is water-dispersible.

10. The method of claim 1, wherein the coating material comprises 10% to 95% by weight of the polymers (P1) and/or (P2), and 5% to 50% by weight of the crosslinking agent (V), based in each case on the nonvolatile constituents of the coating material.

11. The method of claim 1, wherein the thin coat produced with the coating material of the invention has a dry film thickness, after curing, of between 1 and 100 μm.

12. A method of making at least one layer of an OEM coat system, comprising applying the coating material produced by the method of claim 1 to a substrate.

13. The method of claim 12 wherein the coating material is a surfacer coat of an OEM coat system.

14. The method of claim 13, further comprising wherein, in the production of the OEM coat system, the surfacer coat is cured, in further steps a basecoat film and, after flashing off in between, a concluding clearcoat film is applied, and, lastly, the basecoat film and the clearcoat film are jointly cured.

15. The method of claim 13, further comprising wherein, in the production of the OEM coat system, the surfacer coat is applied and flashed off, in further steps a basecoat film and, after flashing off in between, a concluding clearcoat film is applied, and, lastly, the surfacer coat, the basecoat film, and the clearcoat film are jointly cured.
